(19) United States
(12) Patent Application Publication
(10) Pub. No.: US 2009/0256659 A1
(43) Pub. Date: Oct. 15, 2009

(54) CIRCUIT BREAKER WITH IMPROVED CLOSE AND LATCH PERFORMANCE

(76) Inventors: Mahesh Jaywant Rane, Secunderabad (IN); Janakiraman Narayanan, Andra Pradesh (IN); Yatin Vilas Newase, Maharashtra (IN); Sachin Kurkure, Andra Pradesh (IN)

Correspondence Address: General Electric Company;GE Global Patent Operation, PO Box 861, 2 Corporate Drive, Suite 648, Shelton, CT, 06484, US

(21) Appl. No.: 12/103,120

(22) Filed: Apr. 15, 2008

(51) Int. Cl. H01H 75/00

(52) U.S. Cl. 335/16

(57) ABSTRACT

An apparatus includes a plurality of contacts for interrupting current flow when an overcurrent condition occurs, each contact including a mating face displaced at an angle with respect to a pivot point of at least one of the contacts, where the displacement of the mating faces is configured to minimize a repulsion force moment arm from the pivot point of at least one of the contacts.

### BACKGROUND

The disclosed embodiments relate to contacts that conduct current, and in particular, contacts that experience repulsion forces when mating as a result of the amount of current conducted by the contacts.

Circuit breakers are generally used to protect equipment from overcurrent situations caused, for example, by short circuits or ground faults. When an overcurrent condition occurs, electrical contacts within the circuit breaker are designed to open, interrupting current flow through the circuit breaker to the equipment. Circuit breakers may be designed for high quiescent currents and high withstand currents. To maintain a high withstand current rating, the contacts must be locked closed at the current withstand rating and be able to withstand the large electrodynamic repulsion forces generated by the current flow.

Circuit breakers have a variety of designs including blow open and non-blow open contact arms, overcentering and non-overcentering contact arms, single contact pair arrangements with the contact pair at one end of a contact arm and a pivot at the other end, double contact pair arrangements, also referred to as rotary breakers, with a contact pair at each end of a contact arm and a contact arm pivot intermediate the two ends, single housing constructions with the circuit breaker components housed within a single case and cover, and cassette type constructions, also referred to as cassette breakers, with the current carrying components of each phase housed within a phase cassette and each phase cassette in turn housed within a case and cover that may also include an operating mechanism. Multipole circuit breakers are generally available in two, three, and four pole arrangements, with the two and three pole arrangements being used in two and three phase circuits, respectively. Four pole arrangements are typically employed on three phase circuits having switching neutrals, where the fourth pole operates to open and close the neutral circuit in a coordinated arrangement with the opening and closing of the primary circuit phases.

When current carrying contacts of a circuit breaker are closing on a fault, the current through the contacts is very high resulting in significant electromagnetic repulsion forces between the contacts. These electromagnetic repulsion forces impede breaker closing.

FIG. 1 shows a diagram of an exemplary circuit breaker 100. Breaker 100 includes a fixed contact assembly 105 and a movable contact assembly 110 that pivots about a rotation point 115. The movable contact assembly 110 may include one or more first arcing contacts 120 and one or more first main contacts 125. Correspondingly, the fixed contact assembly 105 may include one or more second arcing contacts 130 and one or more second main contacts 135.

The fixed and movable contact assemblies 105, 110 are generally constructed to withstand closing on a fault. When closing on a fault, as the first and second arcing contacts 120, 130 contact each other, the currents flowing through the first and second arcing contacts 120, 130 are close to each other and cause an electromagnetic repulsion force represented by vector 140 due to a constriction effect. The electromagnetic repulsion force acts opposite the applied closing force and applies a torque in a direction opposite the closing rotation of the movable contact assembly 110. The electromagnetic repulsion forces are directly proportional to the magnitude of the current and indirectly proportional to the distance between the contacts when the current flow follows a path of a loop between the contacts.

Thus, the repulsion force 140 is essentially perpendicular to a moment arm 145 representing a distance from the rotation point 115 to the center of the force vector 140. In this embodiment, the moment arm has a significant magnitude resulting in a significant additional closing force required to close the fixed and movable contact assemblies 105, 110.

It would be advantageous to provide a circuit breaker with reduced or redirected repulsion forces.

### BRIEF DESCRIPTION OF THE DISCLOSED EMBODIMENTS

The following are non limiting exemplary embodiments.

In one embodiment, an apparatus includes a plurality of contacts for interrupting current flow when an overcurrent condition occurs, each contact including a mating face displaced at an angle with respect to a pivot point of at least one of the contacts, where the displacement of the mating faces is configured to minimize a repulsion force moment arm from the pivot point of at least one of the contacts.

In another embodiment, a method includes displacing mating faces of a plurality of contacts at an angle with respect to a pivot point of at least one of the contacts, and configuring the displacement to minimize a moment arm from the pivot point of at least one of the contacts to reduce electromagnet repulsion forces between the contacts when an overcurrent condition occurs.

### BRIEF DESCRIPTION OF THE DRAWINGS

The foregoing aspects and other features of the presently disclosed embodiments are explained in the following description, taken in connection with the accompanying drawings, wherein:

FIG. 1 shows a diagram of an exemplary circuit breaker;

FIG. 2 shows an exemplary circuit breaker 200 suitable for practicing the embodiments disclosed herein;

FIG. 3 shows an expanded view of exemplary first and second arcing contacts; and

FIG. 4 shows an expanded view of another embodiment of exemplary first and second arcing contacts.

### DETAILED DESCRIPTION

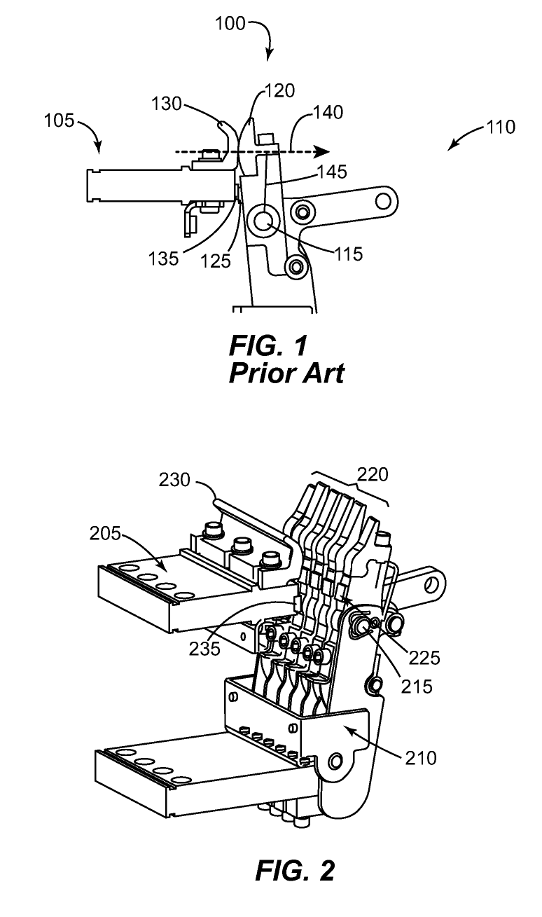

FIG. 2 shows an exemplary circuit breaker 200 suitable for practicing the embodiments disclosed herein. Although the presently disclosed embodiments will be described with reference to the drawings, it should be understood that they may be embodied in many alternate forms. It should also be understood that In addition, any suitable size, shape or type of elements or materials may be used.

The disclosed embodiments may include a plurality of contacts with characteristics that operate to minimize electromagnetic repulsion forces between the contacts.

Circuit breaker 200 may include a fixed contact assembly 205 and a movable contact assembly 210 that pivots about a rotation point 215. The movable contact assembly 210 may generally include one or more first arcing contacts 220 and one or more first main contacts 225. The fixed contact assembly 205 may include one or more second arcing contacts 230 and one or more second main contacts 235. The fixed and movable contact assemblies 205, 210 may be constructed to withstand closing on fault. Upon closing, the first and second arcing contacts 220, 230 may be configured to contact each other before the first and second main contacts 225, 235.

While the disclosed embodiments are described in terms of arcing contacts and main contacts in a circuit breaker, it should be understood that the disclosed embodiments may be utilized with any contacts that are subject to repulsion forces during closing.

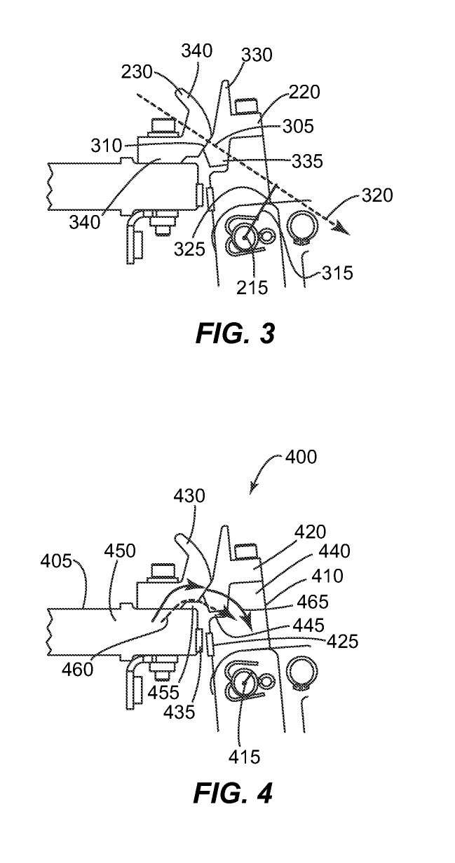

FIG. 3 shows an expanded view of first and second arcing contacts 220, 230. The first and second arcing contacts 220, 230 may have any suitable shape and configuration for minimizing arcing as they contact each other. For example, the first and second arcing contacts 220, 230 may each have a rounded or arcuate contact face 305, 310 having a portion 330, 340 that extends, for example, away from the fixed and movable contact assemblies 205, 210. The shape of the first and second arcing contacts 220, 230 may be a complex shape configured to direct any arcing away from the contacts and towards, for example, an arc quenching device such as a screen or plate located adjacent the first and second arcing contacts 220, 230. The first and second arcing contacts 220, 230 may each have a base 335, 340 for coupling the arcing contacts to the respective fixed and movable contact assemblies 205, 210. Each base 335, 340 may have an L-shape or each base may have any suitable shape.

In this embodiment, the first arcing contact 220 may have a first mating face 305 and the second arcing contact 230 may have a second mating face 310. The first and second mating faces 305, 310 may be disposed at an angle that reduces or minimizes a moment arm 315 from rotation point 215. Due to the angular orientation of the first and second mating faces 305, 310 the currents flowing through the first and second arcing contacts 220, 230 may generally travel further away from each other, or may travel an extended distance through the first and second arcing contacts 220, 230. The electromagnetic repulsion forces may be reduced by introducing a larger loop into the current path as the forces are indirectly proportional to the distance between the contacts when the current flow is in a loop formation.

This may operate to reduce or minimize an electromagnetic repulsion force 320 resulting from the current flowing through the first and second arcing contacts 220, 230.

The angular orientation of the first and second mating faces 305, 310 may also operate to change the direction of the electromagnetic repulsion force 320 applied to the first and second arcing contacts 220, 230. As shown in FIG. 3, the direction of the electromagnetic repulsion force 320 may be directed toward the pivot point 215, and may result in a reduced or minimized moment arm 325. As a result, the electromagnetic repulsion forces may be reduced or minimized.

FIG. 4 shows an expanded view of another embodiment 400 of the first and second arcing contacts. This embodiment may include a fixed contact assembly 405 and a movable contact assembly 410 that pivots about a rotation point 415. Similar to other embodiments, the movable contact assembly 410 may generally include one or more first arcing contacts 420 and one or more first main contacts 425. The movable contact assembly 410 may include a finger 440 on which the first arcing contact 420 is mounted. The fixed contact assembly 405 may include a main conductor 450 on which one or more second arcing contacts 430 and one or more second main contacts 435 are mounted. In this embodiment, a first physical gap 445 may be provided between the finger 440 and the first arcing contact 420. The first gap 445 may operate to extend or lengthen a current path 465 through the first arcing contact by causing the current to travel a longer distance through the first arcing contact 420. A second physical gap 455 may be provided between the main conductor 450 and the second arcing contact 430. Similar to the first gap 445, the second gap 455 may operate to extend or lengthen a current path through the second arcing contact by 430 causing the current to travel a further distance through the second arcing contact by 430.

FIG. 4 shows an exemplary current path 460 that current may travel through the fixed contact assembly 405 and the movable contact assembly 410 in the absence of gaps 445, 455. Current path 465 shows an exemplary current path that may result from the inclusion of gaps 445, 455. Current path 455 may generally have a longer length than current path 445 and may produce a reduced electromagnetic repulsion force between the first arcing contact 420 and the second arcing contact 430.

It should be understood that the foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the appended claims.

1. An apparatus comprising:
a plurality of contacts for interrupting current flow when an overcurrent condition occurs;
each contact including a mating face displaced at an angle with respect to a pivot point of at least one of the contacts,
wherein the displacement of the mating faces is configured to minimize a repulsion force moment arm from the pivot point of at least one of the contacts.

2. The apparatus of claim 1, wherein the displacement of the mating faces is configured to cause current to travel an extended distance through the plurality of contacts.

3. The apparatus of claim 1, wherein the displacement of the mating faces is configured to direct the repulsion force toward the pivot point.

4. The apparatus of claim 1, wherein at least one contact includes a gap configured to cause current to travel an extended distance through the at least one contact.

5. A method comprising:
displacing mating faces of a plurality of contacts at an angle with respect to a pivot point of at least one of the contacts; and
configuring the displacement to minimize a moment arm from the pivot point of at least one of the contacts to reduce electromagnet repulsion forces between the contacts when an overcurrent condition occurs.

6. The method of claim 5, further comprising configuring the displacement of the mating faces to cause current to travel an extended distance through the plurality of contacts.

7. The method of claim 5, further comprising displacing the mating faces to direct the repulsion force toward the pivot point.

8. The method of claim 5, further comprising providing at least one contact with a gap configured to cause current to travel an extended distance through each contact.

9. The apparatus of claim 4, wherein the gap is provided between the at least one contact and a finger on which the at least one contact is mounted within a movable contact assembly.

10. The apparatus of claim 4, wherein the gap is provided between the at least one contact and a main conductor on which the at least one contact is mounted as part of a fixed contact assembly.

11. The method of claim 8, further comprising providing the gap between the at least one contact and a finger on which the at least one contact is mounted within a movable contact assembly.

12. The method of claim 8, further comprising providing the gap between the at least one contact and a main conductor on which the at least one contact is mounted as part of a fixed contact assembly.

13. An apparatus comprising:
a plurality of contacts configured to interrupt current flow upon the occurrence of an overcurrent condition;
each contact including a mating face displaced at an angle with respect to a pivot point of at least one of the contacts, wherein the mating face displacement is configured to minimize a repulsion force moment arm from the pivot point of at least one of the contacts; and
each contact having a gap between the at least one contact and a conductor on which the at least one contact is mounted, wherein the gap is configured to cause current to travel an extended distance through the at least one contact.
